(19) United States
(12) Patent Application Publication
(10) Pub. No.: US 2013/0061749 A1
(43) Pub. Date: Mar. 14, 2013

(54) GAMING MACHINE WITH IONIZED FILTRATION SYSTEM

(71) Applicant: Kehl T. LeSourd, Reno, NV (US)

(72) Inventor: Kehl T. LeSourd, Reno, NV (US)

(73) Assignee: IGT

(21) Appl. No.: 13/227,760

(22) Filed: Sep. 8, 2011

(51) Int. Cl. B03C 3/019

(52) U.S. Cl. 95/70; 96/55

(57) ABSTRACT

An air filtration system may provide effective cooling to a processor or other components of a gaming machine with clean cooling air. The air filtration system may include an ionizer to partially ionize air passing therethrough and to increase sizes of contaminant particles. Some of the contaminant particles may be expelled out of the partially-ionized air, resulting in cleaner air. Cleaner air further passes through a filter, which may further filter out contaminant particles.

### BACKGROUND

1. Field of the Disclosure

The present disclosure relates generally to gaming machines, and more particularly to an air filtration/cooling system within a gaming machine.

2. Description of Related Art

Many of today's gaming casinos and other entertainment locations feature different multi-player gaming systems such as slot machines and video poker machines. These gaming machines typically include pay-for-play (e.g. entertainment arcades, amusement arcades, and so on) or play-for-wager (e.g., casino, video lottery, fixed odds betting, and so on).

The gaming machines may be typically processor-controlled. Microprocessor based gaming machines may include a number of hardware and software components to provide a wide variety of game types and game playing capabilities. A typical electronic gaming machine includes a central processing unit or master gaming controller, generally referred to as CPU below. The CPU may control various combinations of hardware and software devices and components that may encourage game play, may allow a player to play a game on the gaming machine, and may control payouts and other awards.

Software components may include, for example, boot and initialization routines, various game play programs and subroutines, credit and payout routines, image and audio generation programs, various component modules and a random or pseudo-random number generator, among others. Exemplary hardware devices may include bill validators, coin acceptors, card readers, keypads, buttons, levers, touch screens, coin hoppers, ticket printers, player tracking units and the like.

Many gaming machines may be provided with special features and additional circuitry that differentiate them from general-purpose computers, such as a laptop or desktop personal computer (“PC”). Because gaming machines may be highly regulated to ensure fairness, and in many cases may be operable to dispense monetary awards of a large amount of money, their hardware and software architectures often differ significantly from those of general-purpose computers, even though both PCs and gaming machines employ microprocessors to control a variety of devices. In addition, gaming machines generally operate in harsher environments as compared with PCs, and may have more stringent security requirements and fault tolerance requirements. Thus, adapting PC technologies to a gaming machine may be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults may lead to a direct loss of funds, such as stolen cash or loss of revenue when a gaming machine may not be operating properly.

Although the variety of devices available for a PC may be greater than on a gaming machine, gaming machines may have unique device requirements that differ from PCs. For instance, monetary devices such as coin dispensers, bill validators, ticket printers and computing devices that may be used to govern the input and output of cash to a gaming machine have security requirements that may not be typically addressed in PCs. Many PC techniques and methods developed to facilitate device connectivity and device compatibility may not address the emphasis placed on security in the gaming industry. To address some of these issues, a number of hardware/software components and architectures may be utilized in gaming machines that may not be typically found in general purpose computing devices, such as PCs. These hardware/software components and architectures may include, but may not be limited to, items such as watchdog timers, voltage monitoring systems, state-based software architectures and supporting hardware, specialized communication interfaces, security monitoring, and trusted memory.

Gaming machines, including those having three-dimensional graphics or renderings, may be very demanding with respect to amounts of electronic storage space, processing power, and display devices. Thus, some components within gaming machines may become hot and may require a thermal management/cooling system. These components may include, for example, a CPU, light sources, power supplies, transformers, and other electronic circuits.

Some sophisticated thermal management systems may be included in the gaming machine for controlling its internal temperature. Temperatures within a cabinet of a machine may be controlled by monitoring temperatures near heat-producing components (such as a CPU). These thermal management systems may include fans, baffles, temperature sensors, and control signal alarms.

### SUMMARY

According to an example embodiment, a gaming machine may be provided with an air filtration system that may supply cooling air to a component of the gaming machine. An air filtration system may include an ionizer that may partially ionize air passing therethrough and increase sizes of contaminant particles, and a filter that filters out contaminant particles.

In some embodiments, an air filtration system may further include a first sub-system including an ionizer and a first air passage, and a second sub-system including a filter and a second air passage. The first air passage may include a U-turn portion to improve ionization of air molecules by an ionizer.

In some embodiments, a gaming machine may further include an exposed surface to receive some contaminant particles for visual inspection and/or removal. For example, an air filtration system may further have an air conduit communicatively coupling an ionizer and a filter to have partially-ionized air flow therethrough, and an air conduit may have an opening between an ionizer and a filter to release contaminant particles of increased sizes to an exposed surface. In some embodiments, an opening may also release negative ions to an environment of the gaming machine to improve air quality of the environment.

In some embodiments, a component to be cooled may include an electronic circuit, and an ionizer may partially ionize cooling air to an electronic circuit to reduce electrostatic discharge of an electronic circuit.

In some embodiments, an air filtration system may include a first sub-system and a second sub-system. A first subsystem may include a first inlet, an ionizer, a first fan, and a first outlet. A second sub-system may include a second inlet, a filter, a second fan, and a substantially straight air conduit coupling a component to be cooled and a second fan. A first sub-system may have a first airflow circuit therein, and a second sub-system may have a second airflow circuit therein. A first and a second airflow circuit may be coupled. In one example, a first and a second airflow circuit may be coupled through an air conduit having a U-turn portion. A gaming machine may include a cabinet substantially enclosing an air filtration system, wherein a first inlet, a first outlet, and a second inlet may be formed on an outer wall of the cabinet, and wherein a U-turn portion may protrude outside the cabinet. In another example, a first and a second airflow circuit may be coupled through an open space near a first outlet and a second inlet.

According to an example embodiment, a method for cooling a processor of a gaming machine may be provided. A method may include partially ionizing air to increase sizes of contaminant particles contained in the air, and filtering partially ionized air to remove contaminant particles of increased sizes.

In some embodiments, a method may include forming at least two circuits of airflows including: a first circuit through an ionizer for partially ionizing air; and a second circuit through a filter for filtering. In one embodiment, a method may include dividing partially-ionized air from a first circuit into a plurality of second circuits each having a filter. In some embodiments, a method may include depositing some of contaminant particles of increased sizes on an exposed surface for visual inspection and/or removal.

According to another example embodiment, an air filtration system may be provided to supply cooling air to one or more components of a gaming machine. An air filtration system may include an ionizer to partially ionize air passing therethrough and to increase sizes of contaminant particles contained in the air, an exposed external surface on the gaming machine that may receive some contaminant particles of increased sizes, and a filter that may filter out at least some of the remaining contaminant particles of increased sizes.

In some embodiments, an air filtration system may have air flow therethrough at least two airflow circuits including: a first airflow circuit through an ionizer; and a second airflow circuit through a filter. In some embodiments, a plurality of second airflow circuits may be included each having a filter therein, wherein the plurality of second airflow circuits may each receive a portion of partially ionized air from a first circuit to cool a different component.

### BRIEF DESCRIPTION OF THE DRAWINGS

The skilled artisan will understand that the figures, described herein, are for illustration purposes only. It is to be understood that in some instances various aspects of the disclosure may be shown exaggerated or enlarged to facilitate an understanding of the disclosure. In the drawings, like reference characters generally refer to like features, functionally similar and/or structurally similar elements throughout the various figures. The drawings are not intended to limit the scope of the present teachings in any way.

FIG. 1 illustrates an example gaming machine for implementing embodiments disclosed herein.

FIG. 2 is a perspective view of an air filtration system inside a gaming machine.

FIG. 3 is another perspective view of the air filtration system from a different angle.

FIG. 4 is a perspective view of an air filtration system in accordance with another embodiment.

FIG. 5 is another perspective view of an air filtration system according to one embodiment.

FIG. 6 is a close-up view of a portion of the air filtration system illustrating a first airflow circuit.

FIG. 7 is another close-up view of a portion of the air filtration system illustrating a second airflow circuit.

FIG. 8 is a perspective view of the air filtration system illustrating both the first and the second airflow circuits.

### DETAILED DESCRIPTION

Following below are more detailed descriptions of various concepts related to, and embodiments of, inventive methods and apparatus for cooling gaming machines with cleaner air. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

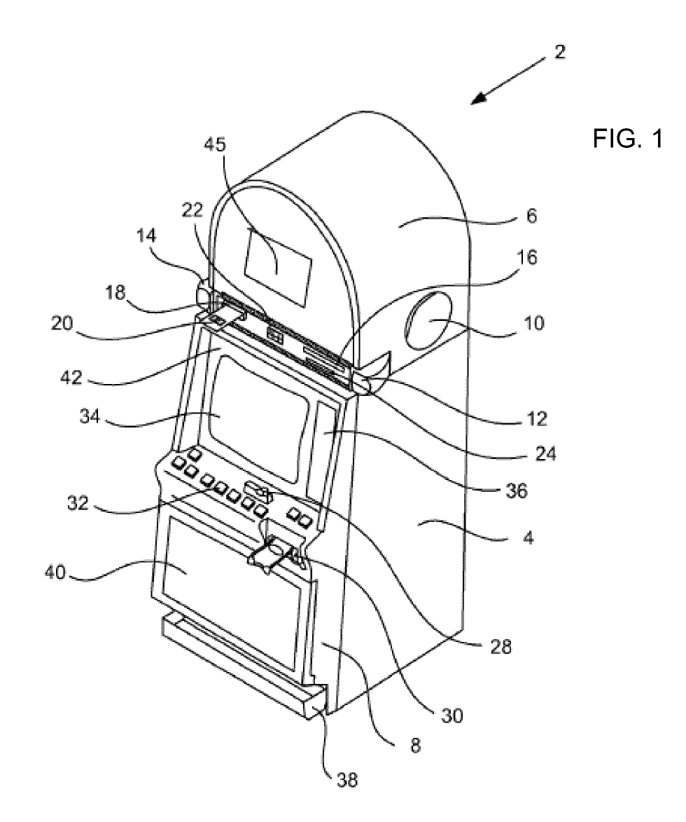

FIG. 1 illustrates an example gaming machine 2 for implementing embodiments detailed below. The gaming machine 2 may include a main cabinet 4, which generally surrounds the machine interior (partially shown in the following drawings). The main cabinet 4 may include a main door 8 on the front of the gaming machine, which opens to provide access to the interior of the machine. Attached to a main door may be player-input switches or buttons 32, a coin acceptor 28, a bill validator 30, a coin tray 38, and a belly glass 40. Viewable through a main door may be a video display monitor 42 having a screen 34 and an information panel 36. The display monitor 42 may be a cathode ray tube (CRT), a flat-panel liquid crystal display (LCD), a light emitting diode (LED) display, a plasma display, or other types of electronically-controlled video monitors. The information panel 36 may be a back-lit, silk screened glass panel with lettering that may indicate general game information including, for example, a game denomination (e.g., $0.25 or $1). A bill validator 30, player-input switches 32, video display monitor 42, and information panel 36 may be devices used to play a game on the gaming machine 2. The devices may be controlled by circuitry (e.g., the CPU) housed inside the main cabinet 4 of the gaming machine 2.

The gaming machine 2 may include a top box 6, which may sit on top of a main cabinet 4. A top box 6 may house a number of devices, which may be used to add features to a game being played on a gaming machine 2, including speakers 10, 12, 14, a ticket printer 18 that may print bar-coded tickets 20, a key pad 22 that may be used for entering player tracking information, a florescent display 16 that may be used for displaying player tracking information, a card reader 24 that may be for entering a magnetic striped card containing player tracking information, and a video display screen 45. The ticket printer 18 may be used to print tickets for a cashless ticketing system. Further, the top box 6 may house different or additional devices. For example, a top box may contain a bonus wheel or a back-lit silk screened panel that may be used to add bonus features to a game being played on the gaming machine 2. As another example, a top box may contain a display for a progressive jackpot offered on the gaming machine 2.

It may be understood that many makes, models, types and varieties of gaming machines exist, that not every such gaming machine may include all or any of the foregoing items, and that many gaming machines may include other items not described above.

Air quality may have a negative impact on gaming machines. For example, in a closed casino environment, the air may have a higher concentration of smoke and dust, which may adversely affect the performance of gaming machines and reduce their lifespan, unless contaminant particles are effectively filtered out and/or interior components of gaming machines are effectively cooled. Fan failures due to air filter contamination from smoke and dust may cause processors to overheat and shut down, shortening lifespan of gaming machines.

Embodiments disclosed herein address several design constraints discussed above. To improve air quality and provide thermal management, an example air filtration system may use both an air ionizer and a filter. By introducing cleaner air prior to circulation within equipment in a closed environment, filter life and filter maintenance cycles may be extended. In one example, a double filtration system may be provided where air may be ionized prior to its ingestion into a force-air filtration sub-system.

An air ionizer may use an electric field at a relatively high voltage to ionize (electrically charge) air molecules. Negative ions, or anions, are particles with one or more extra electrons, and may be formed by conferring net negative charges to the particles through an ionizer. Cations are positive ions missing one or more electrons, resulting in a net positive charge. Commercial air purifiers may be designed to generate negative ions. Another type of air ionizer may generate balanced ions to neutralize static charges which may prevent electrostatic discharge (ESD). In an example embodiment, an air filtration system described herein may use an ESD ionizer.

In one example, an air filtration system may use a method referred to as corona discharge to help increase sizes of contaminant particles. A pulsed power supply may be used to generate positive and negative ions. A molecule passing through an electric field of a corona discharge area may pick up an additional electron, thereby having a negative net charge; or it may have an electron knocked off it, thereby having a positive net charge. Larger particles in the air, such as dust or other contaminants, may be more likely to be ionized because they make larger targets for the electrons when they pass through the corona discharge area. As particles clump together, they grow larger and may be more easily captured by filters. They also grow heavier and may settle out of the air.

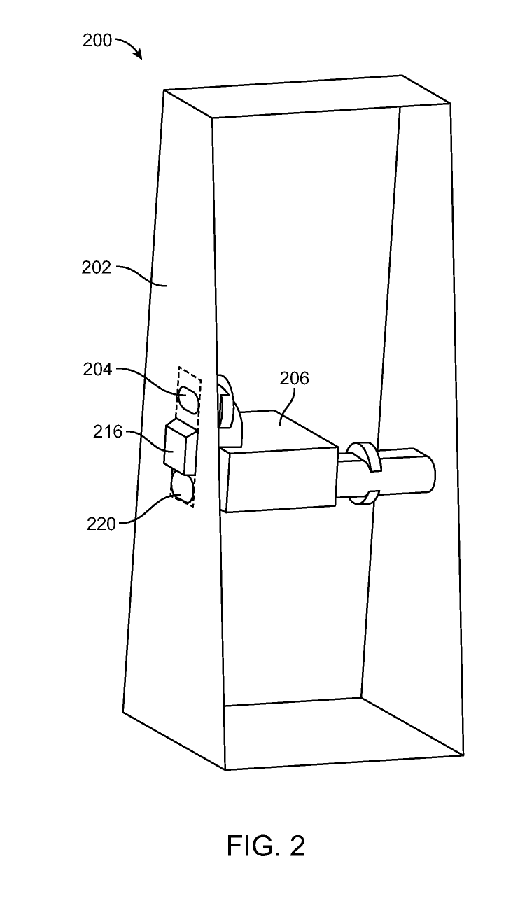

FIG. 2 is a perspective view of a double filtration system for a gaming machine 200 according to one embodiment. A filtration system may first clean air through ionization, independent of a forced-air filtration sub-system. Specifically, as illustrated in FIG. 2, before air may be introduced to a main forced-air filtration sub-system enclosed in a cabinet 202, an ionizer may charge air entering a first air inlet 204 on a cabinet and increases the sizes of contamination particles contained in the air. A forced-air filtration sub-system may filter out these contaminant particles more easily prior to passing cooling air to a CPU 206. This allows a filter to catch more particles that might otherwise have been introduced to the area near a CPU 206.

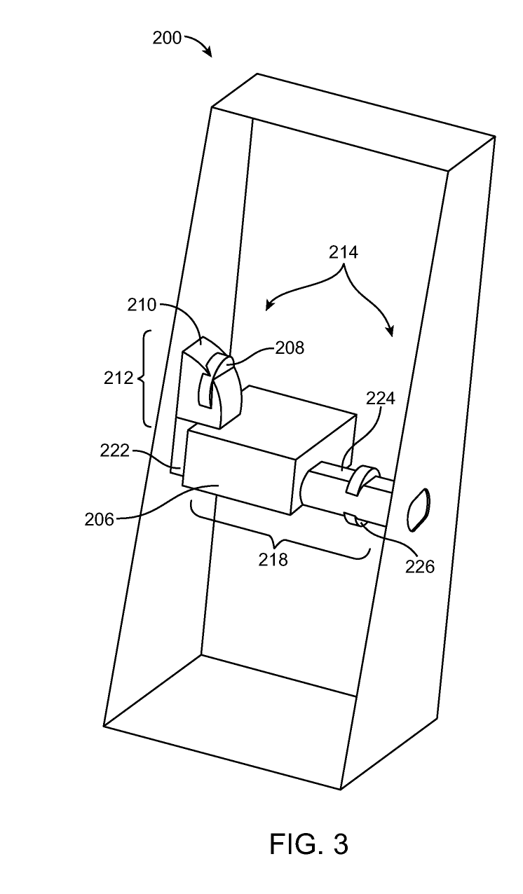

In the embodiment illustrated in FIG. 2, an air filtration system may pull air from outside of a cabinet 202 through a first inlet 204 by a first fan 208. Referring also to FIG. 3—which provides a perspective view of an interior of a gaming machine 200 from an angle different from that of FIG. 2—incoming air through a first inlet 204 may pass through an ionizer 210 and may be partially ionized. Contaminant particles contained in the air may also be electrically charged. Smaller contaminant particles may come together forming larger particles. Larger contaminant particles may be more easily expelled or simply drop out of the air during an ionization processes, resulting in partially-ionized air being cleaner.

A first inlet 204, a first fan 208, and an ionizer 210 may be considered as a first portion, or a first sub-system 212 of an overall air filtration system 214. Airflow along a first passage within a first portion 212 may be referred to as a first “circuit” of air. Although in the embodiment shown in FIG. 2 a first circuit may include one “U” turn, in some other embodiments a first circuit may be more torturous to improve a probability of ionization of air molecules. For example, more “U” turns, zigzag portions, or loops, may be included in a first circuit, by configuring the geometry of an air passage accordingly. In some other examples, to simplify designs and improve air flow efficiency, a straight first circuit may be adopted.

Cleaner air from a first portion 212 may be pushed through a first outlet 216, which may be coupled to a second portion or sub-system 218 (see, e.g., FIG. 3) of an air filtration system 214. In one embodiment, Coupling between a first and a second sub-system 212, 218 may be through an open space outside a cabinet 202 near a first inlet 204, a first outlet 216, and a second inlet 220. In this configuration, cleaner air may be drawn back into a cabinet through a second inlet 220. Some ambient air may be mixed with cleaner air and also drawn into a second inlet 220.

When contaminant particles are sufficiently large after “growth” in the first circuit 230, the contaminant particles of increased sizes may drop or be expelled downward to settle on a floor near a gaming machine, or on an exposed surface of a gaming machine. An exposed surface may be a side surface of a cabinet of a gaming machine 200 or a separate stand, for example. This provides a visual indicator to a cleaning crew that an air filtration system in a gaming machine may need to be cleaned/maintained. An exposed surface that may be dusty may be much more likely to get day-to-day attention for cleaning, as compared to an internal dusty slot machine cabinet not readily visual to human eyes. Furthermore, as some dust particles settle on an exposed surface, they may be easily removed. This may reduce the load of an air filter inside a gaming machine, thereby prolonging the lifespan of an air filter, and reducing the number of maintenance cycles when a cabinet of a gaming machine may be opened for maintenance or replacing a filter.

Although in the embodiment shown in FIG. 3 contaminant particles settle on a side of a gaming machine 200, in some other embodiments a first conduit 234 including an opening 236 may be such that contaminant particles settle at a backside of a gaming machine hidden from view of game players.

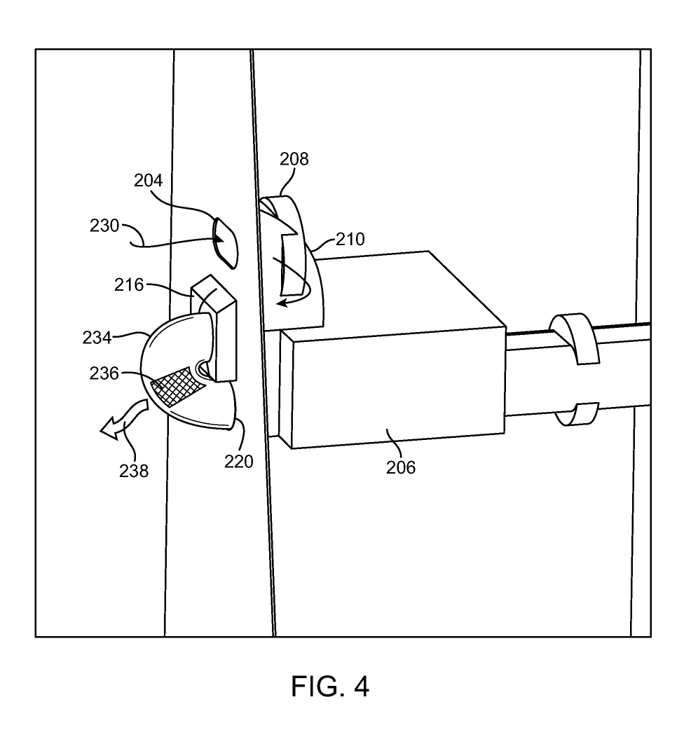

FIG. 4 is a perspective view of an air filtration system in accordance with another embodiment, where an air conduit 234 connecting a first outlet 216 and a second inlet 220 may be included. An opening 236 may be included in a connecting portion between a first and a second airflow circuit 230, 232, or in a second conduit 234. In accordance with some embodiments, a screen may be included in an opening 236. Charged contaminant particles may easily attach to a screen due to Coulomb attraction.

In addition, when contaminant particles are sufficiently large after “growth” in the first circuit 230, they may settle on a screen at an opening 236, or drop or be expelled from an opening 236 downward to settle on a floor or an exposed surface. An exposed surface may be an external surface of a cabinet of a gaming machine 200, or a dedicated stand attached to or near a cabinet. Settled contaminate particles may provide a visual indication that maintenances may be needed for a gaming machine, and/or may be removed easily without removing an air filter inside a gaming machine.

In the embodiment shown in FIG. 4, a first outlet 216 and a second inlet 220 may be formed on an outer wall of a cabinet 202, connected by a first conduit 234 outside a cabinet 202. This configuration may make it easier to upgrade existing gaming machines to include an air filtration system disclosed herein.

In some other embodiments, a first conduit 234 may be enclosed in a cabinet 202 entirely. In that case, a first outlet 216 and a second inlet 220 may not be needed, or at least there may be no need to form them in the cabinet sidewall.

In accordance with one embodiment, partially ionized air 238 from a first circuit 230, particularly air that may contain negative ions, may be allowed to exit an air filtration system and enter a closed environment. As one example of a closed environment, modern casinos containing slot machines, fluorescent lighting, forced air ventilation systems, and modern building materials may generate an overabundance of positive ions. Balancing ionization in such a closed environment may have tranquil and refreshing effects on game players and sharpening of their mental functioning. Filtration systems illustrated in FIGS. 3 and 4 may provide some of benefits by introducing negative ions into an environment using airflow from an ionizer 210. In addition, removal of contaminant particles from casino air by a number of gaming devices may result in a “distributed air cleaner,” thus reducing smoke and particle reduction handling by a plant or central air conditioning equipment.

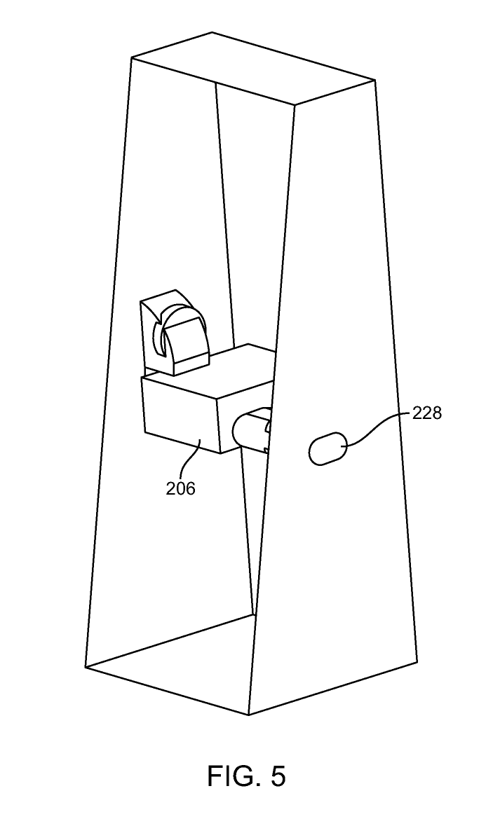

Partially ionized, cleaner air may be introduced back into a cabinet 202 through a second inlet 220. As illustrated in FIG. 3, cleaner air passes through a conventional air filter 222 before reaching a CPU 206. Exhaust air travels through a first air conduit or duct 224, driven by an exhaust fan 226, before exiting a second portion 218 through a second outlet 228 on a cabinet 202 (see, e.g., FIG. 5).

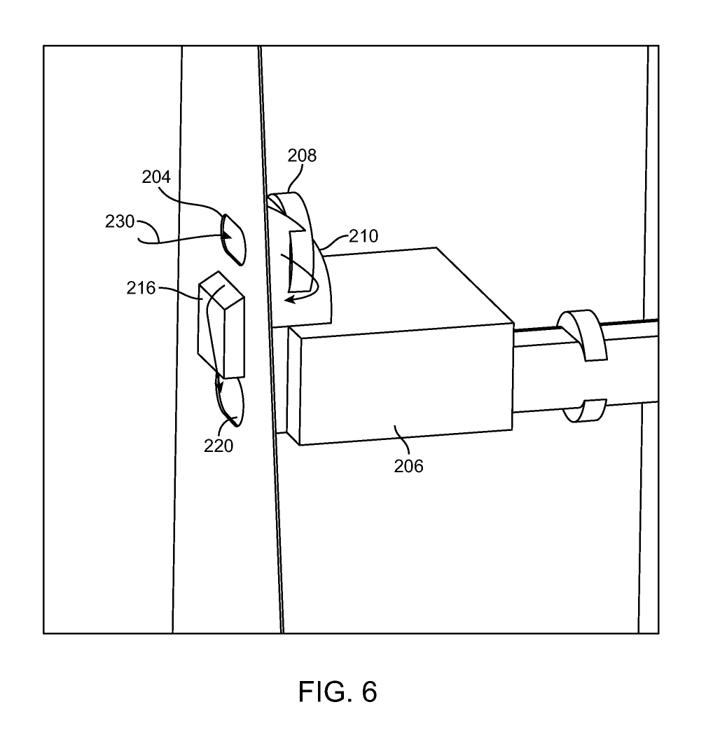

FIG. 6 is close-up view of a first airflow circuit 230, showing a “U” turn of air passing through a first inlet 204, a first fan 208, an ionizer 210, and exiting a first outlet 216. In a configuration where an air conduit 234 may not be used, contaminant particles from a first airflow circuit 230 may be deposited to an exposed external surface of a cabinet 202 near a first outlet 216, or settle to a floor down below. A screen 236 and a stand may not be needed in this case.

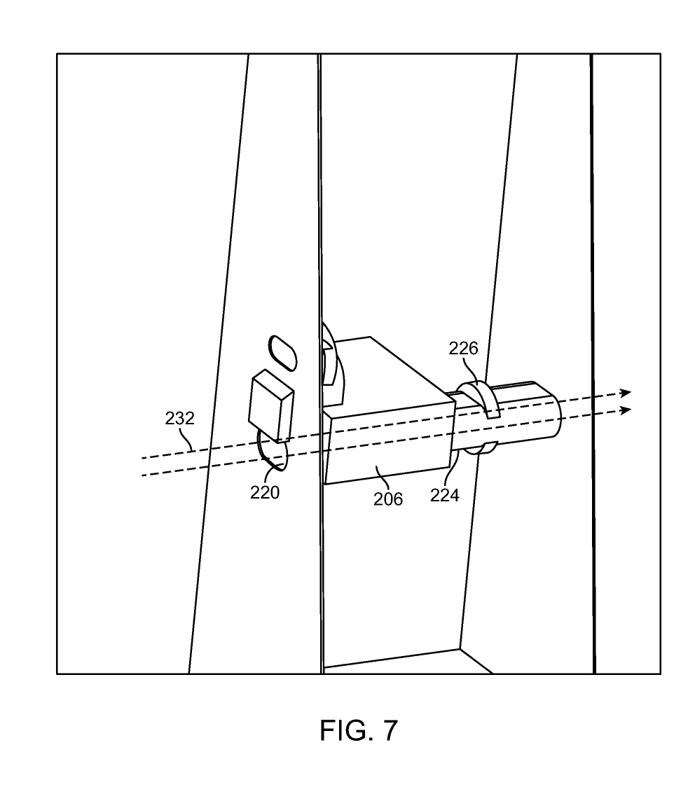

FIG. 7 illustrates a second airflow circuit 232, in which cleaner air from a first circuit 230 may enter a second inlet 220, and pass near a CPU 206, and a first air conduit 224, driven by an exhaust fan 226. In this example, a second airflow circuit 232 may be substantially straight, including a substantially straight first air conduit 224.

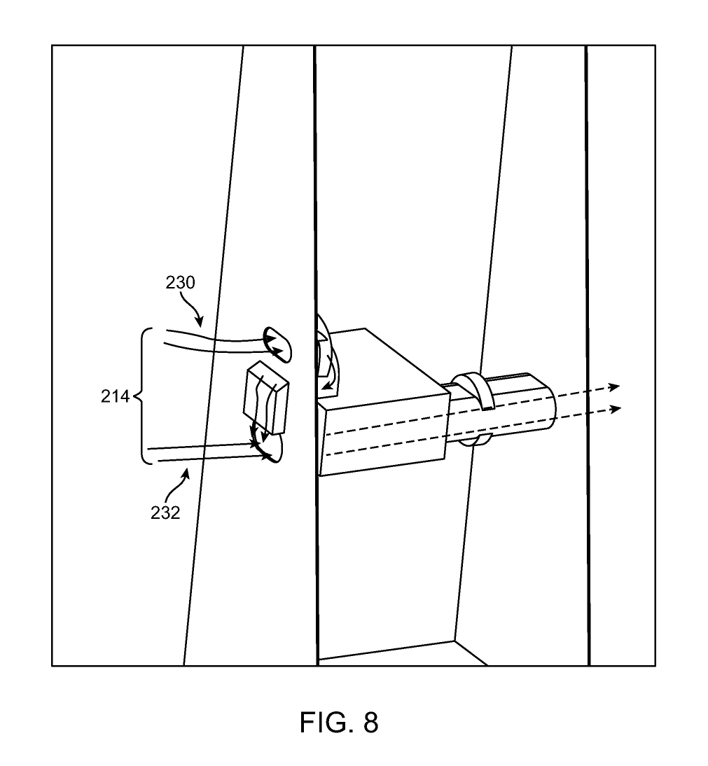

FIG. 8 provides another view of an air filtration system 214, including a first airflow circuit 230, and a second airflow circuit 232. Although in this example a first circuit 230 may include a “U” turn, and a second circuit 232 may be substantially straight, many other variations are possible.

For example, a first and a second airflow circuit may both be substantially straight and collinear, and collectively form a substantially straight air passage. This configuration may simplify a system and improve air flow efficiency. In another embodiment, a first airflow circuit may include two or more U-turn portions. More U-turns or torturous portions help improve ionization efficiency, and allow sufficient air passage length for contaminant particles to grow in sizes. In another embodiment, a first and a second circuit form a substantially complete loop, using a circular air conduit.

In yet another embodiment, an air filtration system may include a plurality of second airflow circuits that each receive a portion of partially ionized air from a first circuit. This configuration may reduce the cost of an air filtration system by sharing cleaner, partially-ionized air from an ionizer among a plurality of cooling paths, each having a low-cost filter therein, to cool a plurality of components (such as a CPU, a display, or other electronic components) inside a gaming machine. In an alternative embodiment, a plurality of gaming machines may share a central ionizer.

Advantageously, an air filtration system and methods disclosed herein may provide better filtration, extended life, and reduce ESD effect of a gaming machine in a closed environment.

Although illustrative embodiments and applications of this disclosure may be shown and described herein, many variations and modifications may be possible which remain within the concept, scope, and spirit of the disclosure, and these variations would become clear to those of ordinary skill in the art after perusal of this application. While the various embodiments have involved gaming machines, other types of components and devices that may not be player oriented but having electronic circuits that may take advantage of cleaner cooling air may also use the systems and methods described herein. Accordingly, the embodiments described are to be considered as illustrative and not restrictive, and the disclosure is not to be limited to the details given herein, but may be modified within the scope and equivalents of the appended claims.

The claims should not be read as limited to the described order or elements unless stated to that effect. It should be understood that various changes in form and detail may be made by one of ordinary skill in the art without departing from the spirit and scope of the appended claims.

All embodiments that come within the spirit and scope of the following claims and equivalents thereto are claimed.

1. A gaming machine comprising:
an air filtration system to supply cooling air to a component of the gaming machine, wherein the air filtration system comprises:
an ionizer configured to partially ionize air passing therethrough and to increase sizes of contaminant particles contained in the air; and
a filter configured to filter out the contaminant particles of increased sizes.

2. The gaming machine of claim 1, wherein the air filtration system further comprises:
a first sub-system including the ionizer and a first air passage; and
a second sub-system including the filter and a second air passage.

3. The gaming machine of claim 2, wherein the first sub-system is configured to have a first airflow circuit therein, wherein the second sub-system is configured to have a second airflow circuit therein, and wherein the first and second airflow circuits are configured to release the contaminant particles of increased sizes to an external exposed surface of the gaming machine, the contaminant particles being released at a location where the first and second airflow circuits are communicatively coupled.

4. The gaming machine of claim 2, wherein the first air passage includes a U-turn portion.

5. The gaming machine of claim 1, further comprising an exposed surface to receive some of the contaminant particles for visual inspection and/or removal.

6. The gaming machine of claim 5, wherein the air filtration system further comprises:
an air conduit communicatively coupling the ionizer and the filter to have the partially-ionized air flow therethrough,
wherein the air conduit has an opening between the ionizer and the filter to release the contaminant particles of increased sizes to the exposed surface.

7. The gaming machine of claim 6, wherein the opening is configured to release negative ions to an environment of the gaming machine to improve air quality of the environment.

8. The gaming machine of claim 1, wherein the component comprises an electronic circuit, and wherein the ionizer is configured to partially ionize the cooling air to the electronic circuit to thereby reduce electrostatic discharge of the electronic circuit.

9. The gaming machine of claim 1, wherein the air filtration system includes:
a first sub-system comprising:
a first inlet;
the ionizer;
a first fan; and
a first outlet; and
a second sub-system comprising:
a second inlet;
the filter;
a second fan; and
a substantially straight air conduit communicatively coupling the component to be cooled and the second fan.

10. The gaming machine of claim 9, wherein the first sub-system is configured to have a first airflow circuit therein, wherein the second sub-system is configured to have a second airflow circuit therein, and wherein the first and second airflow circuits are communicatively coupled.

11. The gaming machine of claim 10, wherein the first and second airflow circuits are communicatively coupled through an air conduit having a U-turn portion.

12. The gaming machine of claim 11, further comprising a cabinet substantially enclosing the air filtration system, wherein the first inlet, the first outlet, and the second inlet are formed on an outer wall of the cabinet, and wherein the U-turn portion protrudes outside the cabinet.

13. The gaming machine of claim 10, wherein the first and second airflow circuits are communicatively coupled through an open space adjacent the first outlet and the second inlet.

14. A method for cooling a processor of a gaming machine, the method comprising:
partially ionizing air to increase sizes of contaminant particles contained in the air; and
filtering the partially ionized air to remove the contaminant particles of increased sizes.

15. The method of claim 14, further comprising forming at least two circuits of airflows including:
a first circuit through an ionizer for said partially ionizing air; and
a second circuit through a filter for said filtering.

16. The method of claim 15, further comprising dividing the partially-ionized air from the first circuit into a plurality of second circuits each having a filter.

17. The method of claim 14, further comprising depositing some of the contaminant particles of increased sizes on an exposed surface for visual inspection and/or removal.

18. An air filtration system to supply cooling air to one or more components of a gaming machine, the air filtration system comprising:
an ionizer to partially ionize air passing therethrough and to increase sizes of contaminant particles contained in the air;
an exposed external surface on the gaming machine to receive some of the contaminant particles of increased sizes; and
a filter to filter out at least some of the remaining contaminant particles of increased sizes.

19. The air filtration system of claim 18, wherein the air filtration system is configured to have air flow therethrough as at least two airflow circuits including:
a first airflow circuit through the ionizer; and
a second airflow circuit through the filter.

20. The air filtration system of claim 19, further comprising a plurality of second airflow circuits each having a filter therein, wherein the plurality of second airflow circuits are each configured to receive a portion of partially ionized air from the first circuit to cool a different component.
